(19) United States
(12) Patent Application Publication
(10) Pub. No.: US 2018/0165190 A1
(43) Pub. Date: Jun. 14, 2018

(54) GARBAGE COLLECTION FOR CHUNK-BASED STORAGE SYSTEMS

(71) Applicant: EMC IP Holding Company LLC, Hopkinton, MA (US)

(72) Inventors: Mikhail Danilov, Saint Petersburg (RU); Konstantin Buinov, Kirovsk City (RU); Kirill Gusakov, Saint Petersburg (RU); Sergey Koyushev, Saint Petersburg (RU); Mikhail Malygin, Saint Petersburg (RU)

(73) Assignee: EMC IP Holding Company LLC, Hopkinton, MA (US)

(21) Appl. No.: 15/620,898

(22) Filed: Jun. 13, 2017

(30) Foreign Application Priority Data
Dec. 13, 2016 (RU) 2016148858

(51) Int. Cl. G06F 12/02; G06F 3/06

(52) U.S. Cl. CPC G06F 12/0261; G06F 3/0641; G06F 3/0608; G06F 3/0631; G06F 3/067

(57) ABSTRACT

A computer program product, system, and method for receiving I/Os to write a plurality of objects; allocating one or more storage chunks for the plurality of objects; storing the objects as segments within the allocated storage chunks; receiving an I/O to delete an object from the plurality of objects; detecting one or more dedicated storage chunks from one or more storage chunks in which the object to delete is stored; determining one or more unused chunks from the one or more of the dedicated chunks; and deleting the unused chunks and reclaiming storage capacity for the unused chunks.

### CROSS REFERENCE TO RELATED APPLICATIONS

This application claims priority to Russian Patent Application number 2016148858, filed Dec. 13, 2016, and entitled “IMPROVED GARBAGE COLLECTION FOR CHUNK-BASED STORAGE SYSTEMS,” which is incorporated herein by reference in its entirety.

### BACKGROUND

As is known in the art, data storage systems may partition storage capacity into blocks of fixed sizes sometimes referred to as “chunks.” Chunks may be used to store objects (i.e., a blob of user data), as well as object metadata. A given chunk may store information for multiple objects. Some data storage systems include a garbage collection (GC) facility whereby storage capacity allocated to chunks may be reclaimed. Garbage collection performance is a known issue for many existing storage systems.

### SUMMARY

According to one aspect of the disclosure, a method comprises: receiving I/Os to write a plurality of objects; allocating one or more storage chunks for the plurality of objects; storing the objects as segments within the allocated storage chunks; receiving an I/O to delete an object from the plurality of objects; detecting one or more dedicated storage chunks from one or more storage chunks in which the object to delete is stored; determining one or more unused chunks from the one or more of the dedicated chunks; and deleting the unused chunks and reclaiming storage capacity for the unused chunks.

In some embodiments, the method further comprises: receiving hints from a client about the size of one or more of the plurality of objects; and marking one or more of the allocated storage chunks using a special chunk type in response to receiving the hints from the client, wherein detecting one or more dedicated storage chunks includes detecting storage chunks having the special chunk type. In some embodiments, determining the one or more unused chunks from the one or more of the dedicated chunks includes determining the one or more unused chunks using an object table.

In certain embodiments, detecting the one or more dedicated storage chunks includes using an object table to find chunks that belong to single objects. In particular embodiments, using the object table to find chunks that belong to single objects includes: determining an amount of data within a sealed chunk; and using the object table to find an object having the amount of data within the sealed chunk.

According to another aspect of the disclosure, a system comprises one or more processors; a volatile memory; and a non-volatile memory storing computer program code that when executed on the processor causes execution across the one or more processors of a process operable to perform embodiments of the method described hereinabove.

According to yet another aspect of the disclosure, a computer program product tangibly embodied in a non-transitory computer-readable medium, the computer-readable medium storing program instructions that are executable to perform embodiments of the method described hereinabove.

### BRIEF DESCRIPTION OF THE DRAWINGS

The concepts, structures, and techniques sought to be protected herein may be more fully understood from the following detailed description of the drawings, in which:

FIG. 1 is a block diagram of an illustrative distributed storage system, in accordance with an embodiment of the disclosure;

FIG. 1A is a block diagram of an illustrative storage node which may form a part of the distributed storage system of FIG. 1, in accordance with an embodiment of the disclosure;

FIG. 2 is a diagram of an illustrative storage chunk layout, in accordance with an embodiment of the disclosure;

FIG. 3 is a flow diagram illustrating processing that may occur within a storage system, in accordance with embodiments; and

FIG. 4 is block diagram of a computer on which the processing of FIG. 3 may be implemented, according to an embodiment of the disclosure.

The drawings are not necessarily to scale, or inclusive of all elements of a system, emphasis instead generally being placed upon illustrating the concepts, structures, and techniques sought to be protected herein.

### DETAILED DESCRIPTION

Before describing embodiments of the structures and techniques sought to be protected herein, some terms are explained. As used herein, the phrases “computer,” “computing system,” “computing environment,” “processing platform,” “data memory and storage system,” and “data memory and storage system environment” are intended to be broadly construed so as to encompass, for example, private or public cloud computing or storage systems, or parts thereof, as well as other types of systems comprising distributed virtual infrastructure and those not comprising virtual infrastructure. The terms “application,” “program,” “application program,” and “computer application program” herein refer to any type of software application, including desktop applications, server applications, database applications, and mobile applications.

As used herein, the term “storage device” refers to any non-volatile memory (NVM) device, including hard disk drives (HDDs), flash devices (e.g., NAND flash devices), and next generation NVM devices, any of which can be accessed locally and/or remotely (e.g., via a storage attached network (SAN)). The term “storage device” can also refer to a storage array comprising one or more storage devices.

In certain embodiments, the term “storage system” may encompass private or public cloud computing systems for storing data as well as systems for storing data comprising virtual infrastructure and those not comprising virtual infrastructure. In some embodiments, the term “I/O request” (or simply “I/O”) may refer to a request to read and/or write data. In many embodiments, the terms “client,” “user,” and “application” may refer to any person, system, or other entity that may send I/O requests to a storage system.

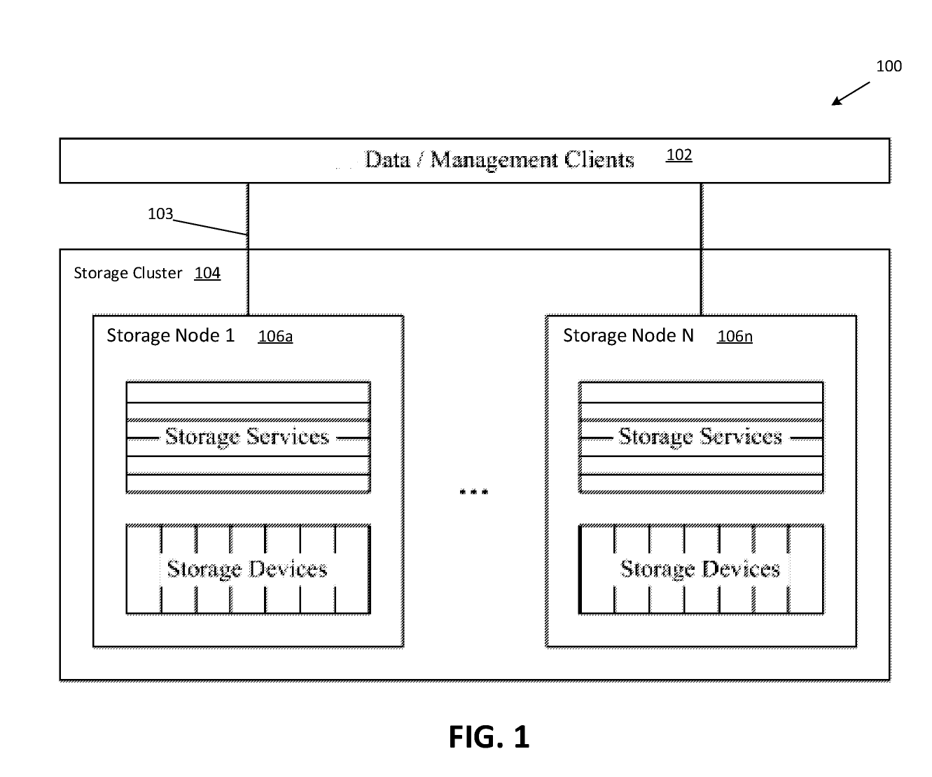

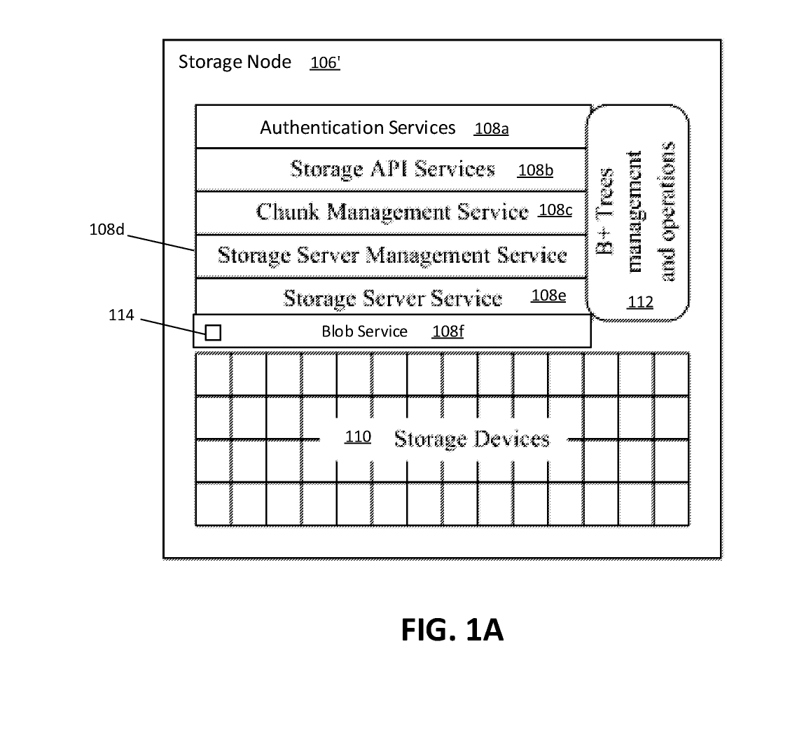

FIG. 1 shows a distributed storage system in accordance with an embodiment of the disclosure. An illustrative distributed storage system 100 includes one or more clients 102 in communication with a storage cluster 104 via a network 103. The network 103 may include any suitable type of communication network or combination thereof, including networks using protocols such as Ethernet, Internet Small Computer System Interface (iSCSI), Fibre Channel (FC), and/or wireless protocols. The clients 102 may include user applications, application servers, data management tools, and/or testing systems. The storage cluster 104 includes one or more storage nodes 106a . . . 106n (generally denoted 106). An illustrative storage node is shown in FIG. 1A and described below in conjunction therewith.

In general operation, clients 102 issue requests to the storage cluster 104 to read and write data. Write requests may include requests to store new data and requests to update previously stored data. Data read and write requests include an ID value to uniquely identify the data within the storage cluster 104. A client request may be received by any available storage node 106. The receiving node 106 may process the request locally and/or may delegate request processing to one or more peer nodes 106. For example, if a client issues a data read request, the receiving node may delegate/proxy the request to peer node where the data resides.

In various embodiments, the distributed storage system 100 comprises an object storage system, wherein arbitrary-sized blobs of user data is read and written in the form of objects, which are uniquely identified by object IDs. In some embodiments, the storage cluster 104 utilizes Elastic Cloud Storage (ECS) from Dell EMC of Hopkinton, Mass.

In many embodiments, the storage cluster 104 stores object data and various types of metadata within fixed-sized chunks. The contents of a chunk may be appended to until the chunk becomes “full” (i.e., until its capacity is exhausted or nearly exhausted). When a chunk becomes full, it may be marked as “sealed.” The storage cluster 104 treats sealed chunks as immutable.

In certain embodiments, the storage cluster 104 utilizes different types of chunks. For example, objects may be stored in so-called “repository” or “repo” chunks. As another example, object metadata may be stored in tree-like structures stored within “tree” chunks.

In some embodiments, a repository chunk may include of one or more “segments,” each of which may correspond to data for a single object. In particular embodiments, a given object may be stored within one or more repository chunks and a given repository chunk may store multiple objects. In many embodiments, a repository chunk may be referred to as a “dedicated chunk” if all its segments correspond to a single object, and otherwise may be referred to as a “shared chunk.”

FIG. 1A shows a storage node 106′, which may be the same as or similar to a storage node 106 in FIG. 1, in accordance with an embodiment of the disclosure. The illustrative storage node 106′ includes one or more services 108a-108f (108 generally), one or more storage devices 110, and a search tree module 112. A storage node 106′ may include a processor (not shown) configured to execute instructions provided by services 108 and/or module 112.

In the embodiment of FIG. 1A, a storage node 106′ includes the following services: an authentication service 108a to authenticate requests from clients 102; storage API services 108b to parse and interpret requests from clients 102; a storage chunk management service 108c to facilitate storage chunk allocation/reclamation for different storage system needs and monitor storage chunk health and usage; a storage server management service 108d to manage available storage devices capacity and to track storage devices states; a storage server service 108e to interface with the storage devices 110; and a blob service 108f to track the storage locations of objects in the system.

The blob service 108f may maintain an object table 114 that includes information about which repository chunk (or chunks) each object is stored within. TABLE 1 illustrates the type of information that may be maintained within the object table 114.

TABLE 1

Location Info

| Object ID | Chunk ID | Offset | Length |
|---|---|---|---|
| 1 | X | 0 | 2 |
| | X | 4 | 1 |
| 2 | X | 2 | 2 |

In various embodiments, the storage chunk management service (or “chunk manager”) 108c performs garbage collection. In some embodiments, garbage collection may be implemented at the chunk level. In certain embodiments, before a repository chunk can be reclaimed, the chunk manager 108c must ensure that no objects reference the chunk. In some embodiments, the storage cluster may use reference counting to facilitate garbage collection. For example, a per-chunk counter may be incremented when an object segment is added to a chunk and decremented when an object that references the chunk is deleted.

It is appreciated herein that accurate reference counting may be difficult (or even impossible) to achieve within a distributed system, such as storage cluster 104. Thus, in some embodiments, reference counting may be used merely to identify chunks that are candidates for garbage collection. For example, a chunk may be treated as a GC candidate if its reference counter is zero. In various embodiments, the chunk manager 108c may perform a separate verification procedure to determine if GC-candidate chunk can safely be deleted and its storage capacity reclaimed. In many embodiments, the chunk manager 108c, in coordination with the blob service 108f, may scan the entire object table 114 to verify that no live objects have a segment within a GC-candidate chunk. In some embodiments, chunk manager 108c may delete a chunk and reclaim its capacity only after the verification is complete.

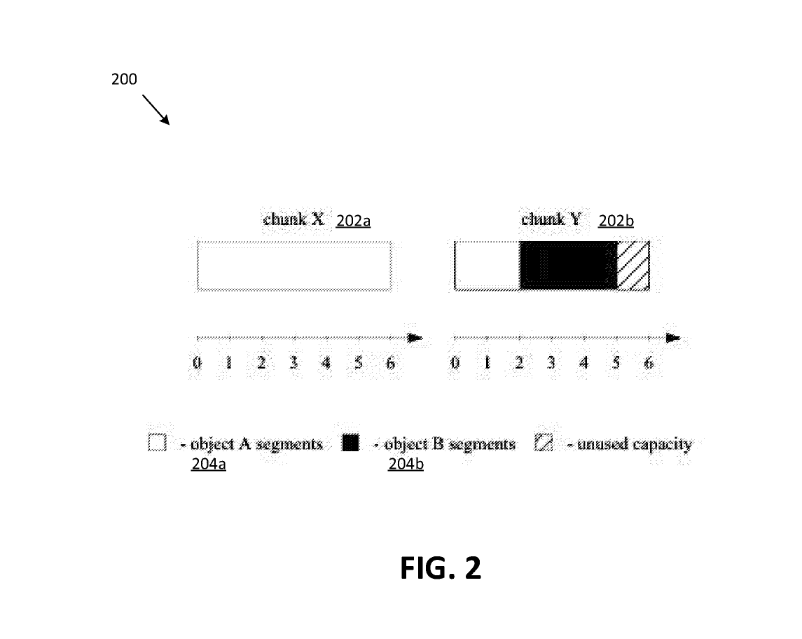

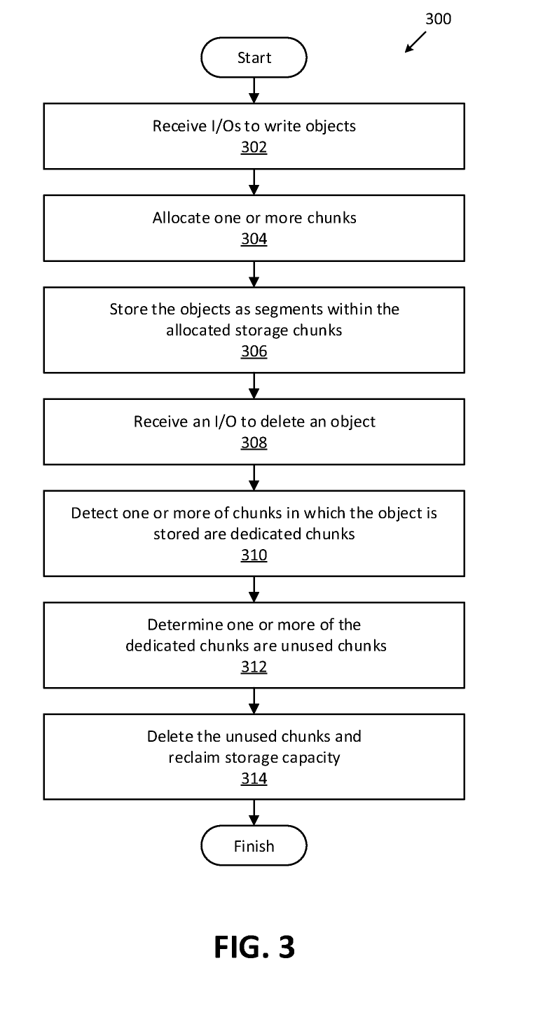

In some embodiments the object table 114 may be stored to disk and, thus, scanning the object table may be an I/O-intensive operation. In various embodiments, a storage system may improve garbage collection efficiency by treating dedicated chunks as special case, as described below in conjunction with FIGS. 2 and 3.

Referring to FIG. 2, a storage system 200 may have one or more repository chunks 202a-202b (202 generally) storing one or more objects 204a-204b (204 generally), according to an embodiment. As shown in FIG. 2, a first object 204a may be stored within chunks 202a and 202b and a second object 204b may be stored within 202b. Chunk 202a may be referred to as a “dedicated chunk” because all of its segments correspond to a single object (i.e., object 204a), and chunk 202b may be referred to as a “shared chunk” because it includes segments from multiple objects (i.e., objects 204a and 204b).

In some embodiments, dedicated chunks can be generated in different ways. In particular embodiments, the storage system may allow a user to specify an object's size (sometimes referred to as “hint”) before the object is uploaded to the system. In such embodiments, the storage system may explicitly allocate one or more dedicated chunks for sufficiently large objects. In certain embodiments, chunks that are explicitly allocated and dedicated to large objects may be assigned a special chunk type (e.g., “Type-II”).

In some embodiments, dedicated chunks may be the implicit result of certain I/O write patterns. In certain embodiments, implicitly-created dedicated chunks may be more likely to occur in single-threaded applications. In some embodiments, the storage system may intentionally seal chunks that are not yet full in order to increase the percentage of dedicated chunks within the system.

TABLE 2 shows an example of location information that may be maintained within an object table (e.g., object table 114 of FIG. 1A) for the storage system 200.

TABLE 2

Location Info

| Object ID | Chunk ID | Offset | Length |
|---|---|---|---|
| A (204a) | X (202a) | 0 | 6 |
| | Y (202b) | 0 | 2 |
| B (204b) | Y (202b) | 2 | 2 |

In many embodiments, the storage system may detect and garbage-collect dedicated chunks when an object is deleted. In some embodiments, this process may be referred to as “immediate” garbage collection.

Referring again to FIG. 2, the storage system 200 may use different techniques to detect dedicated chunks. In some embodiments, chunks that where explicitly allocated and dedicated to large objects may be detected based on the chunk type (e.g., “Type-II”).

In particular embodiments, the storage system may detect dedicated chunks using the following heuristic: (1) when a chunk is sealed, the storage system may track the amount of data (e.g., number of bytes) written to the chunk up to that point; (2) the storage system can use the object table to determine if any object has that same amount of data stored within the chunk; and (3) if so, the storage system determines that the chunk is a dedicated chunk because no other object can have data within the same chunk. For example, referring to FIG. 2 and TABLE 2, when object 204a is deleted, the storage system can determine, using the object table, that object 204a occupies six units of chunk 202a capacity; knowing that six units of data were written to chunk 202a at the time it was sealed, the storage system can efficiently determine that chunk 202a is a dedicated chunk.

Referring back to FIG. 2, once a dedicated chunk is detected, the storage system can use the object table to determine if the chunk is unused and, thus, can be deleted and have its storage capacity reclaimed. In some embodiments, when an object is deleted, the storage system performs a lookup in the object table based on the deleted object's ID; if lookup returns nothing, it is guaranteed that any chunks that are dedicated to that object are not in use and can be safely deleted.

FIG. 3 is a flow diagram showing illustrative processing in accordance with certain embodiments of the disclosure. The processing may be implemented within one or more storage nodes 106 of a storage cluster 104 (FIG. 1). Rectangular elements (typified by element 302) herein denoted “processing blocks,” represent computer software instructions or groups of instructions. Alternatively, the processing blocks may represent steps performed by functionally equivalent circuits such as a digital signal processor circuit or an application specific integrated circuit (ASIC). The flow diagrams do not depict the syntax of any particular programming language. Rather, the flow diagrams illustrate the functional information one of ordinary skill in the art requires to fabricate circuits or to generate computer software to perform the processing required of the particular apparatus. It should be noted that many routine program elements, such as initialization of loops and variables and the use of temporary variables are not shown. It will be appreciated by those of ordinary skill in the art that unless otherwise indicated herein, the particular sequence of blocks described is illustrative only and can be varied without departing from the spirit of the concepts, structures, and techniques sought to be protected herein. Thus, unless otherwise stated the blocks described below are unordered meaning that, when possible, the functions represented by the blocks can be performed in any convenient or desirable order.

Referring to FIG. 3, a process 300 may begin at block 302, where I/O requests are received to write objects. At block 304, one or more chunks are allocated to store the objects. In some embodiments, an I/O write request includes a hint about an object size and one or more of the allocated chunks may be explicitly allocated as a dedicated chunk for that object and assigned a special chunk type (e.g., “Type-II”). In certain embodiments, one or more of the allocated chunks may implicitly be a dedicated chunk for one of the objects.

At block 306, the objects may be stored as segments within the allocated storage chunks. In many embodiments, block 306 may also include updating an object table (e.g., table 114 in FIG. 1A) to associate to track which chunk segment (or segments) are used to store each of the objects.

At block 308, an I/O request may be received to delete an object. The object may be stored as segments within one or more chunks. At block 310, one or more of the chunks in which the object is stored are detected to be dedicated chunks. In some embodiments, the dedicated chunks may be detected based on a special chunk type (e.g., “Type-II”). In certain embodiments, the dedicated chunks may be detected using the object table, as described above in conjunction with FIG. 2.

At block 312, one or more of the dedicated chunks are determined to be unused chunks. In certain embodiments, this includes performing a lookup in the object table based on the deleted object's ID; if lookup returns nothing, it is guaranteed that any chunks that are dedicated to that object are not in use and can be safely deleted.

At block 314, the unused chunks may be deleted and the corresponding storage capacity may be reclaimed.

It is appreciated that the structures and techniques disclosed herein can provide significant performance improvements to garbage collection within storage systems, particularly for systems that store a high percentage of “large objects.”

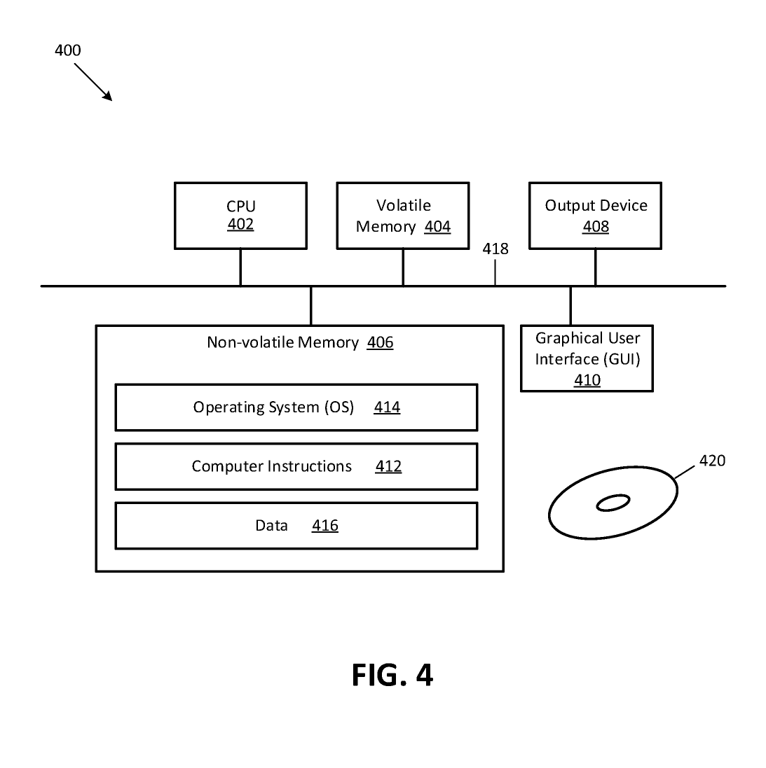

FIG. 4 shows an illustrative computer or other processing device 400 that can perform at least part of the processing described herein, according to an embodiment of the disclosure. The computer 400 includes a processor 402, a volatile memory 404, a non-volatile memory 406 (e.g., hard disk), an output device 408 and a graphical user interface (GUI) 410 (e.g., a mouse, a keyboard, a display, for example), each of which is coupled together by a bus 418. The non-volatile memory 406 stores computer instructions 412, an operating system 414, and data 416. In one example, the computer instructions 412 are executed by the processor 402 out of volatile memory 404.

In some embodiments, a non-transitory computer readable medium 420 may be provided on which a computer program product may be tangibly embodied. The non-transitory computer-readable medium 420 may store program instructions that are executable to perform the processing of FIG. 3.

Processing may be implemented in hardware, software, or a combination of the two. In various embodiments, processing is provided by computer programs executing on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform processing and to generate output information.

The system can perform processing, at least in part, via a computer program product, (e.g., in a machine-readable storage device), for execution by, or to control the operation of, data processing apparatus (e.g., a programmable processor, a computer, or multiple computers). Each such program may be implemented in a high level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer. Processing may also be implemented as a machine-readable storage medium, configured with a computer program, where upon execution, instructions in the computer program cause the computer to operate.

Processing may be performed by one or more programmable processors executing one or more computer programs to perform the functions of the system. All or part of the system may be implemented as special purpose logic circuitry (e.g., an FPGA (field programmable gate array) and/or an ASIC (application-specific integrated circuit)).

All references cited herein are hereby incorporated herein by reference in their entirety.

Having described certain embodiments, which serve to illustrate various concepts, structures, and techniques sought to be protected herein, it will be apparent to those of ordinary skill in the art that other embodiments incorporating these concepts, structures, and techniques may be used. Elements of different embodiments described hereinabove may be combined to form other embodiments not specifically set forth above and, further, elements described in the context of a single embodiment may be provided separately or in any suitable sub-combination. Accordingly, it is submitted that scope of protection sought herein should not be limited to the described embodiments but rather should be limited only by the spirit and scope of the following claims.

What is claimed is:

1. A method comprising:
receiving I/Os to write a plurality of objects;
allocating one or more storage chunks for the plurality of objects;
storing the objects as segments within the allocated storage chunks;
receiving an I/O to delete an object from the plurality of objects;
detecting one or more dedicated storage chunks from one or more storage chunks in which the object to delete is stored;
determining one or more unused chunks from the one or more of the dedicated chunks; and
deleting the unused chunks and reclaiming storage capacity for the unused chunks.

2. The method of claim 1 further comprising:
receiving hints from a client about the size of one or more of the plurality of objects; and
marking one or more of the allocated storage chunks using a special chunk type in response to receiving the hints from the client,
wherein detecting one or more dedicated storage chunks includes detecting storage chunks having the special chunk type.

3. The method of claim 1 wherein detecting the one or more dedicated storage chunks includes using an object table to find chunks that belong to single objects.

4. The method of claim 3 wherein using the object table to find chunks that belong to single objects includes:
determining an amount of data within a sealed chunk; and
using the object table to find an object having the amount of data within the sealed chunk.

5. The method of claim 1 wherein determining the one or more unused chunks from the one or more of the dedicated chunks includes determining the one or more unused chunks using an object table.

6. A system comprising:
a processor;
a volatile memory; and
a non-volatile memory storing computer program code that when executed on the processor causes the processor to execute a process operable to perform the operations of:
receiving I/Os to write a plurality of objects;
allocating one or more storage chunks for the plurality of objects;
storing the objects as segments within the allocated storage chunks;
receiving an I/O to delete an object from the plurality of objects;
detecting one or more dedicated storage chunks from one or more storage chunks in which the object to delete is stored;
determining one or more unused chunks from the one or more of the dedicated chunks; and
deleting the unused chunks and reclaiming storage capacity for the unused chunks.

7. The system of claim 6 wherein the computer program code that when executed on the processor causes the processor to execute a process further operable to perform the operations of:
receiving hints from a client about the size of one or more of the plurality of objects; and
marking one or more of the allocated storage chunks using a special chunk type in response to receiving the hints from the client,
wherein detecting one or more dedicated storage chunks includes detecting storage chunks having the special chunk type.

8. The system of claim 6 wherein detecting the one or more dedicated storage chunks includes using an object table to find chunks that belong to single objects.

9. The system of claim 8 wherein using the object table to find chunks that belong to single objects includes:
determining an amount of data within a sealed chunk; and
using the object table to find an object having the amount of data within the sealed chunk.

10. The system of claim 6 wherein determining the one or more unused chunks from the one or more of the dedicated chunks includes determining the one or more unused chunks using an object table.

11. A computer program product tangibly embodied in a non-transitory computer-readable medium, the computer-readable medium storing program instructions that are executable to:
receive I/Os to write a plurality of objects;
allocate one or more storage chunks for the plurality of objects;
store the objects as segments within the allocated storage chunks;
receive an I/O to delete an object from the plurality of objects;
detect one or more dedicated storage chunks from one or more storage chunks in which the object to delete is stored;
determine one or more unused chunks from the one or more of the dedicated chunks; and
delete the unused chunks and reclaiming storage capacity for the unused chunks.

12. The computer program product of claim 11 wherein program instructions are further executable to:
receive hints from a client about the size of one or more of the plurality of objects; and
mark one or more of the allocated storage chunks using a special chunk type in response to receiving the hints from the client,
wherein detecting one or more dedicated storage chunks includes detecting storage chunks having the special chunk type.

13. The computer program product of claim 11 wherein detecting the one or more dedicated storage chunks includes using an object table to find chunks that belong to single objects.

14. The computer program product of claim 13 wherein using the object table to find chunks that belong to single objects includes:
determining an amount of data within a sealed chunk; and
using the object table to find an object having the amount of data within the sealed chunk.

15. The computer program product of claim 11 wherein determining the one or more unused chunks from the one or more of the dedicated chunks includes determining the one or more unused chunks using an object table.
